(19) United States
(12) Patent Application Publication
(10) Pub. No.: US 2004/0250165 A1
(43) Pub. Date: Dec. 9, 2004

(54) Semiconductor memory device permitting boundary scan test

(75) Inventor: Tetsushi Tanizaki, Hyogo (JP)

Correspondence Address: McDermott, Will & Emery, 600 13th Street, N.W., Washington, DC, 20005-3096, US

(73) Assignee: RENESAS TECHNOLOGY CORP.

(21) Appl. No.: 10/649,682

(22) Filed: Aug. 28, 2003

(30) Foreign Application Priority Data
Mar. 14, 2003 (JP) 2003-069416(P)

(51) Int. Cl. H02H 3/05

(52) U.S. Cl. 714/30

(57) ABSTRACT

A boundary scan cell in a semiconductor memory device (memory core) is provided corresponding to each terminal for performing a boundary scan test. A test controller and a read/write control circuit cause the boundary scan cell to latch input write data in a late write operation, until a next write cycle of the write cycle at which the write data was input from the terminal.

### BACKGROUND OF THE INVENTION

1. Field of the Invention

The present invention relates to semiconductor memory devices, and more particularly to a semiconductor memory device which has a logic and a memory, and selectively performs a high-speed random cycle write operation and a boundary scan test operation.

2. Description of the Background Art

In a semiconductor memory device, a large number of operation steps are required before input data is written into a core circuit. This elongates a processing time, and hinders writing at high-speed cycles.

As a way of solving the problems, Japanese Patent Laying-Open No. 2001-243798, for example, enables a high-speed random cycle write operation in a late write operation. The late write operation is a write operation which is started in response to a rising of a control signal. According to Japanese Patent Laying-Open No. 2001-243798, in the late write operation, upon receipt of data and a write instruction for the data, the device temporarily stores the data in an internal buffer, rather than writing it into a memory cell in a core circuit. Thereafter, the device writes the data held in the internal buffer into a memory cell in the core circuit only when a write instruction for next data is input. The data corresponding to the latter write instruction is stored in the data buffer, and remains therein until a next write instruction is input.

On the other hand, a write operation which is started in response to a falling of a write control signal is called an early write operation.

A variety of system LSI (Large Scale Integrated circuits), each having a circuit block (integrated circuit device) constituting the semiconductor memory device and a circuit block (integrated circuit device) having a logic function mounted together on the same board, have been proposed, and widely used for portable equipment and others.

A boundary scan test (JTAG (joint test action group) test) standardized in IEEE (IEEE Std. 1149.1) is performed on the device mounted on a board. The boundary scan test is performed by sequentially scanning all external input/output pin terminals of the integrated circuit device for inputting/outputting boundary scan test data, to test the internal functions of the integrated circuit device and the board on which the device is mounted. In the JTAG test, shift registers are arranged corresponding to the input/output pin terminals, and the boundary scan test data is transferred serially through the shift registers to test connections between the integrated circuit devices, between the pin terminals of the integrated circuit device and the board, and others.

The semiconductor memory device provided with the functions allowing the high-speed random cycle write operation and the boundary scan test operation as described above, however, suffer the following problems.

Firstly, to perform the high-speed random cycle write operation, buffers corresponding to the respective data input terminals are required for holding data until a next cycle. The number of data input terminals is huge particularly in the semiconductor memory device mounted to a system LSI.

For the boundary scan test function, shift registers corresponding to the respective input/output terminals are also required.

As such, the semiconductor memory device provided with the buffers for the high-speed random cycle write operation and the shift registers for the boundary scan test requires a huge circuit area.

### SUMMARY OF THE INVENTION

An object of the present invention is to provide a semiconductor memory device which selectively performs a high-speed random cycle write operation and a boundary scan test operation, without increasing a circuit area.

A semiconductor memory device according to an aspect of the present invention has a logic and a memory and selectively performs a late write operation and a boundary scan test operation. The semiconductor memory device includes: a terminal receiving write data; an input buffer provided corresponding to the terminal; a boundary scan cell provided corresponding to the terminal and including a first register holding boundary scan test data at the time of the boundary scan test and holding write data to the memory supplied from the terminal at the time of the late write operation in accordance with inactivation of a write control signal; a first selector receiving an output of the input buffer and an output of the boundary scan cell and selecting the output of the boundary scan cell in the late write operation; and a write driver for writing the output selected by the selector into the memory.

According to the semiconductor memory device of the present invention, it is possible to selectively perform the high-speed random cycle write operation and the boundary scan test operation without increasing the circuit area.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of a system LSI according to a first embodiment of the present invention.

FIG. 2 shows a detailed configuration of a boundary scan cell 5.

FIG. 3 shows a detailed configuration of an input buffer 2.

FIG. 4 shows a detailed configuration of a boundary scan cell 1.

FIG. 5 shows input/output signals of a multiplexer 4.

FIG. 6 is a timing chart illustrating a late write operation.

FIG. 7 is a timing chart illustrating an early write operation.

FIG. 8 shows a configuration of a system LSI according to a second embodiment of the present invention.

FIG. 9 shows a detailed configuration of a boundary scan cell 15.

FIG. 10 shows input/output signals of a multiplexer 9.

### DESCRIPTION OF THE PREFERRED EMBODIMENTS

Hereinafter, embodiments of the present invention will be described with reference to the drawings.

<First Embodiment>

(Configuration)

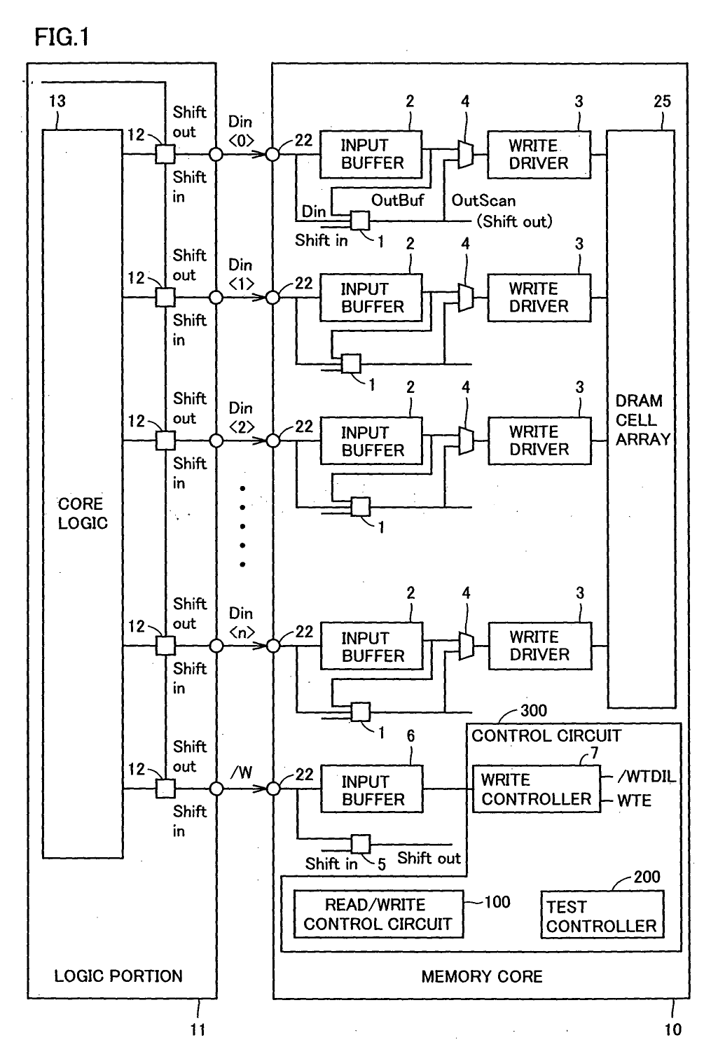

FIG. 1 shows a configuration of the system LSI according to the first embodiment. Referring to FIG. 1, the system LSI includes a logic portion 11 and a memory core 10.

Logic portion 11 and memory core 10 are connected via a readily controllable SRAM (static random access memory) interface. That is, the SRAM interface allows input of a row address and a column address, rather than a multiplexed address signal, to memory core 10 separately from each other, and also permits direct input of a write or read control signal.

Logic portion 11 includes a core logic 13 and a plurality of boundary scan cells 12.

(Core Logic 13)

Core logic 13 performs prescribed processing. It outputs a write control signal /W and write data.

In an early write operation, the write data is output to satisfy a timing defined by setup tsu(D) and hold th(D) with respect to a falling of write control signal /W.

On the other hand, in a late write operation, the write data is output to satisfy a timing defined by setup tsu(D) and hold th(D) with respect to a rising of write control signal /W.

(Boundary Scan Cell 12)

Boundary scan cells 12 are connected in series to constitute a scan chain of the core logic.

Boundary scan cell 12 lets write control signal /W through for output. It lets the write data through for output in the write operation, and outputs the data held therein upon the boundary scan test.

Memory core 10, being a semiconductor memory device, includes a plurality of boundary scan cells 1, a plurality of input buffers 2, a plurality of write drivers 3, a plurality of multiplexers 4, a DRAM cell array 25, an input buffer 6, a boundary scan cell 5, a test controller 200, and a read/write control circuit 100. As shown in FIG. 1, test controller 200, read/write control circuit 100 and write controller 7 constitute a control circuit 300.

(DRAM Cell Array 25)

DRAM cell array 25 has DRAM (dynamic random access memory) cells arranged in rows and columns. Each DRAM cell uses a capacitor as a storage element, and occupies a small area compared to the SRAM cell.

(Test Controller 200)

Test controller 200, being a controller supporting a JTAG test, generates control signals necessary for the boundary scan test.

Specifically, test controller 200 generates a shift operation mode designating signal ShiftDR and a transfer clock signal ClockDR based on an externally supplied control signal (not shown). Shift operation mode designating signal ShiftDR attains an H level during a shift operation of the boundary scan test. Transfer clock signal ClockDR is asserted (to an H level) periodically during the shift operation and a capture operation of the boundary scan test.

Read/Write Control Circuit 100)

Read/write control circuit 100 controls each circuit in memory core 10 upon writing and reading of data to and from a memory cell. Read/write control circuit 100 generates a write operation mode select signal DLYWT. Read/write control circuit 100 sets write operation mode select signal DLYWT to an L level in the early write operation and to an H level in the late write operation.

(Input Buffer 6)

Input buffer 6, including a delay circuit (not shown), delays write control signal /W received from an input port 22 by a prescribed time Δt1 and outputs the resultant signal as a delayed write control signal.

(Write Controller 7)

Write controller 7 generates a write data take-in signal /WTDIL and a write driver control signal WTE based on the delayed write control signal output from input buffer 6. Specifically, write controller 7 generates one-shot pulse write driver control signal WTE (of an H level) in synchronization with a falling of the delayed write control signal. It also generates one-shot pulse write data take-in signal /WTDIL (of an L level) in synchronization with a falling of the delayed write control signal in the early write operation, and in synchronization with a rising of the delayed write control signal in the late write operation.

(Boundary Scan Cell 5)

Boundary scan cell 5, identical to the conventional boundary scan cell, is provided corresponding to write control signal /W. Boundary scan cell 5 and boundary scan cell 1 are connected in series. In the shift operation of the boundary scan test, boundary scan test data is output from each boundary scan cell as a shift-out signal “Shift out”, and is input to a boundary scan cell in a succeeding stage as a shift-in signal “Shift in”.

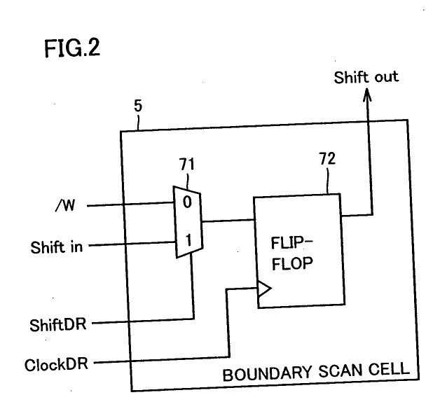

FIG. 2 shows a detailed configuration of boundary scan cell 5. Referring to FIG. 2, a multiplexer 71 is provided with an input signal /W from input port 22, and shift-in signal “Shift in” from boundary scan cell 1 in the preceding stage.

In the capture operation of the boundary scan test, shift operation mode designating signal ShiftDR of an L level is supplied from test controller 200, and multiplexer 71 selects and outputs the boundary scan test data provided as input signal /W (i.e., the data indicating the state of input port 22 at the time of the test).

In the shift operation of the boundary scan test, shift operation mode designating signal ShiftDR attains an H level, and multiplexer 71 selects and outputs shift-in signal “Shift in” (i.e., the boundary scan test data sent from the boundary scan cell in the preceding stage).

In the capture operation of the boundary scan test, a flip-flop 72 latches the boundary scan test data provided as input signal /W, in accordance with transfer clock signal ClockDR supplied from test controller 200.

In the shift operation of the boundary scan test, flip-flop 72 latches shift-in signal “Shift in” output from the boundary scan cell in the preceding stage (i.e., the boundary scan test data sent from the boundary scan cell in the preceding stage), in accordance with transfer clock signal ClockDR, and outputs a shift-out signal “Shift out”. This shift-out signal “Shift out” is input to the boundary scan cell in the succeeding stage as shift-in signal “Shift in”.

(Input Buffer 2)

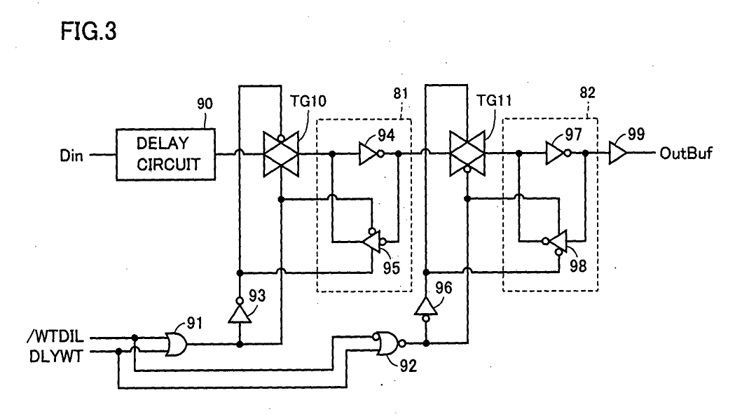

FIG. 3 shows a detailed configuration of input buffer 2. Referring to FIG. 3, input buffer 2 is provided with an input signal Din from input port 22. A delay circuit 90 delays input signal Din by Δt2. In the write operation, write data take-in signal /WTDIL attains an L level.

In the early write operation, write operation mode select signal DLYWT attains an L level. At this time, when write data take-in signal /WTDIL is at an H level, a transfer gate TG10 is rendered conductive, while a transfer gate TG11 is not conductive. By comparison, when write data take-in signal /WTDIL is at an L level, transfer gate TG11 is rendered conductive, while transfer gate TG10 is not conductive.

That is, in the early write operation, input signal Din, after delayed by Δt2, is passed through transfer gate TG10 while write data take-in signal /WTDIL is at an H level, and is latched at a latch circuit 81. When write data take-in signal /WTDIL attains an L level, the latched signal is passed through transfer gate TG11 and latched by a latch circuit 82, and also is output as a buffer output signal OutBuf.

On the other hand, in the late write operation, write operation mode select signal DLYWT attains an H level. At this time, transfer gates TG10 and TG11 are both rendered conductive, irrelevant to the level of write data take-in signal /WTDIL. As such, in the late write operation, input signal Din, delayed by Δt2, is passed therethrough and output as buffer output signal OutBuf.

(Boundary Scan Cell 1)

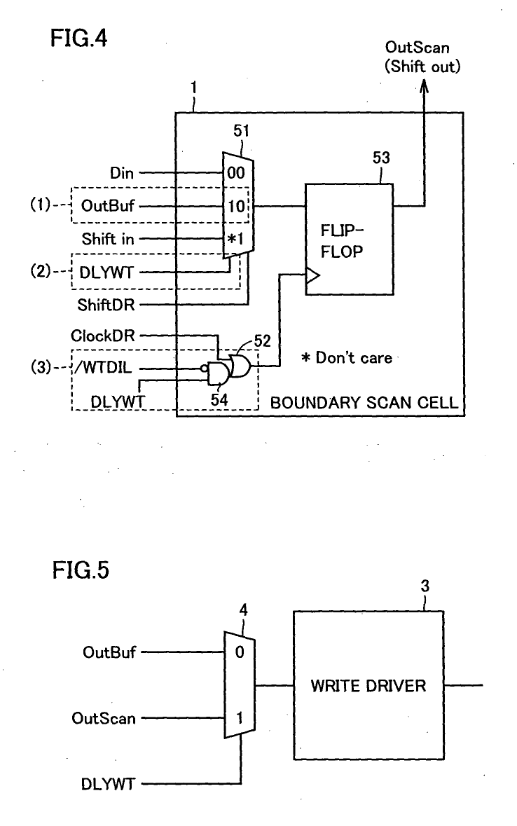

FIG. 4 shows a detailed configuration of boundary scan cell 1. Referring to FIG. 4, a multiplexer 51 is provided with input signal Din from input port 22, buffer output signal OutBuf from input buffer 2, and shift-in signal “Shift in” from boundary scan cell 1 in the preceding stage (i.e., the boundary scan test data sent from the boundary scan cell in the preceding stage).

In the early write operation, write operation mode select signal DLYWT attains an L level, and multiplexer 51 selects and outputs write data provided as input signal Din.

In the late write operation, write operation mode select signal DLYWT attains an H level, and multiplexer 51 selects and outputs buffer output signal OutBuf.

In the capture operation of the boundary scan test, shift operation mode designating signal ShiftDR is at an L level. Thus, multiplexer 51 selects and outputs the boundary scan test data provided as input signal Din.

In the shift operation of the boundary scan test, shift operation mode designating signal ShiftDR attains an H level. Thus, multiplexer 51 selects and outputs shift-in signal “Shift in” (i.e., the boundary scan test data sent from the boundary scan cell in the preceding stage).

An AND gate 54 receives an inverted signal of write data take-in signal /WTDIL and write operation mode select signal DLYWT. AND gate 54 outputs the inverted signal of write data take-in signal /WTDIL in the late write operation (i.e., when DLYWT=H level). AND gate 54 outputs a signal always at an L level in the early write operation (i.e., when DLYWT=L level).

An OR gate 52 receives transfer clock signal ClockDR of the boundary scan test and an output signal of AND gate 54, and provides its output to a flip-flop 53.

With AND gate 54 and OR gate 52, the inverted signal of write data take-in signal /WTDIL is output in the late write operation, the signal always at an L level is output in the early write operation, and transfer clock signal ClockDR is output in the capture and shift operations of the boundary scan test.

Flip-flop 53 is a one-bit shift register included in a conventional boundary scan cell. Flip-flop 53 latches the signal output from multiplexer 51 in accordance with the signal output from OR gate 52, and outputs an output signal.

Specifically, in the late write operation, flip-flop 53 latches buffer output signal OutBuf in accordance with write data take-in signal /WTDIL, and outputs a scan cell output signal OutScan.

In the capture operation of the boundary scan test, flip-flop 53 latches the boundary scan test data provided as input signal Din in accordance with transfer clock signal ClockDR, and outputs the boundary scan test data as shift-out signal “Shift out”. This shift-out signal “Shift out” is input to the boundary scan cell in the succeeding stage as shift-in signal “Shift in”.

Further, in the shift operation of the boundary scan test, flip-flop 53 latches shift-in signal “Shift in” output from the boundary scan cell in the preceding stage (i.e., the boundary scan test data sent from the boundary scan cell in the preceding stage) in accordance with transfer clock signal ClockDR, and outputs shift-out signal “Shift out”. This shift-out signal “Shift out” is input to the boundary scan cell in the succeeding stage as shift-in signal “Shift in”.

In FIG. 4, portions indicated by dotted lines (1) to (3) have been added to a conventional boundary scan cell. As shown in FIG. 4, the boundary scan cell of the present embodiment is configured simply by adding a gate formed of AND gate 54 and OR gate 52 to the conventional boundary scan cell and by changing the two-input multiplexer in the conventional boundary scan cell to a three-input multiplexer. As such, an increase in circuit area of the boundary scan cell of the present embodiment with respect to the conventional boundary scan cell is small.

(Multiplexer 4)

FIG. 5 shows input/output signals of multiplexer 4. As shown in FIG. 5, multiplexer 4 receives buffer output signal OutBuf from input buffer 2, and scan cell output signal OutScan from boundary scan cell 1.

In the early write operation, write operation mode select signal DLYWT attains an L level, and multiplexer 4 selects and outputs buffer output signal OutBuf. In the late write operation, write operation mode select signal attains an H level, and multiplexer 4 selects and outputs scan cell output signal OutScan.

(Write Driver 3)

Write driver 3 writes either buffer output signal OutBuf or scan cell output signal OutScan output from multiplexer 4 into a prescribed memory cell in DRAM cell array 25 at a timing of assertion of write driver control signal WTE (to an H level).

(Late Write Operation)

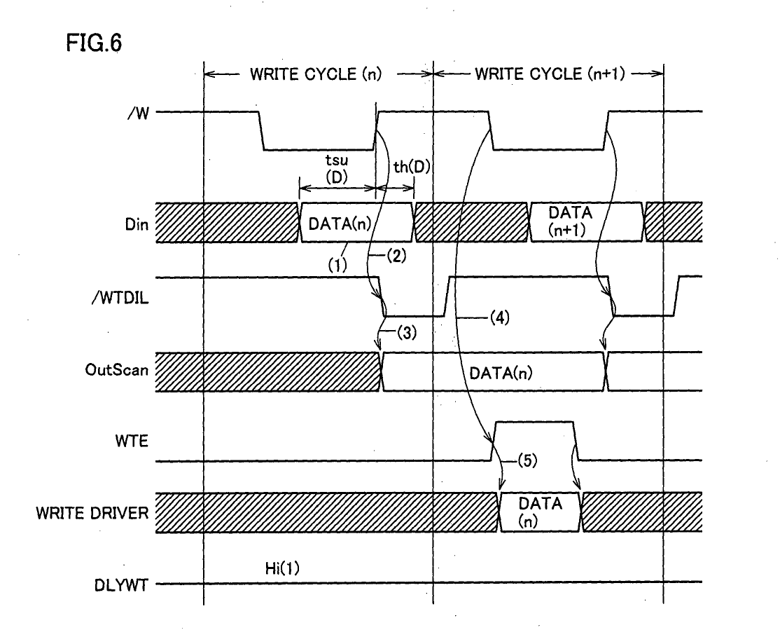

Now, an operation at the time of late write is described with reference to the timing chart shown in FIG. 6.

In the late write operation, write data DATA(n) is input to satisfy a timing defined by setup tsu(D) and hold th(D) with respect to a rising of write control signal /W (as shown in (1) in FIG. 6).

Input buffer 6 outputs a delayed write control signal by delaying received write control signal /W by a prescribed time Δt1. Write controller 7 generates one-shot pulse write data take-in signal /WTDIL (of an L level) in synchronization with a rising of the delayed write control signal (as shown in (2) in FIG. 6).

In input buffer 2, with write operation mode select signal DLYWT being at an H level, write data DATA(n) input as input signal Din is delayed by a prescribed time Δt2, and then passed therethrough and output as buffer output signal OutBuf.

Multiplexer 51 in boundary scan cell 1 selects and outputs buffer output signal OutBuf, since shift operation mode designating signal ShiftDR is at an L level and write operation mode select signal DLYWT is at an H level. Flip-flop 53 latches buffer output signal OutBuf output from multiplexer 51 in accordance with write data take-in signal /WTDIL, and outputs the same as scan cell output signal OutScan. Here, flip-flop 53 holds buffer output signal OutBuf from the time when write data take-in signal /WTDIL is asserted (to an L level) until the next assertion of write data take-in signal /WTDIL (to an L level). That is, flip-flop 53 holds the write data input from input port 22 until a next write cycle. Multiplexer 4 selects and outputs scan cell output signal OutScan in accordance with write operation mode select signal DLYWT of an H level (as shown in (3) in FIG. 6).

Write controller 7 generates one-shot pulse write driver control signal WTE (of an H level) in synchronization with a falling of the delayed write control signal (as shown in (4) in FIG. 6).

Write driver 3 writes scan cell output signal OutScan output from multiplexer 4 into a prescribed memory cell within DRAM cell array 25 at a timing of assertion of write driver control signal WTE (to an H level) (as shown in (5) in FIG. 6).

(Early Write Operation)

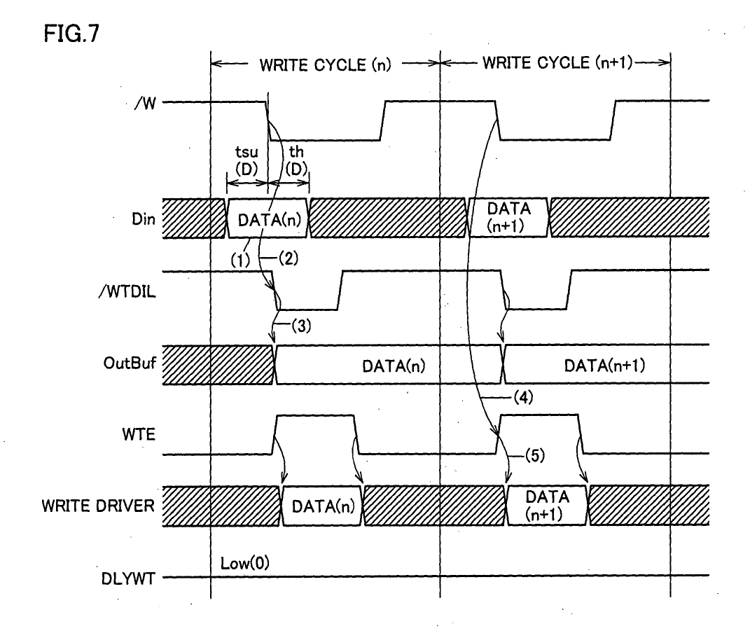

Now, an operation at the time of early write is described with reference to the timing chart shown in FIG. 7.

In the early write operation, write data DATA(n) is input to satisfy a timing defined by setup tsu(D) and hold th(D) with respect to a falling of write control signal /W (as shown in (1) in FIG. 7).

Input buffer 6 receives write control signal /W and outputs a delayed write control signal by delaying the same by a prescribed time Δt1. Write controller 7 generates one-shot pulse write data take-in signal /WTDIL (of an L level) in synchronization with a falling of the delayed write control signal (as shown in (2) in FIG. 7).

In input buffer 2, with write operation mode select signal DLYWT being at an L level, write data DATA(n) input as input signal Din is delayed by a prescribed time Δt2, passed through transfer gate TG10 while write data take-in signal /WTDIL is at an H level, and latched by latch circuit 81. When write data take-in signal /WTDIL attains an L level, it is passed through transfer gate TG11 and latched by latch circuit 82, and is also output as buffer output signal OutBuf. Multiplexer 4 selects and outputs buffer output signal OutBuf, since write operation mode select signal DLYWT is at an L level (as shown in (3) in FIG. 7).

Write controller 7 generates one-shot pulse write driver control signal WTE (of an H level) in synchronization with a falling of the delayed write control signal (as shown in (4) in FIG. 7).

Write driver 3 writes input buffer output signal OutBuf output from multiplexer 4 into a prescribed memory cell within DRAM cell array 25 at the timing of assertion of write driver control signal WTE (to an H level) (as shown in (5) in FIG. 7).

(Boundary Scan Test Operation)

Now, an operation at the time of boundary scan test is described.

In the capture operation of the boundary scan test, multiplexer 51 in boundary scan cell 1 selects and outputs the boundary scan test data input as input signal Din. Flip-flop 53 latches input signal Din output from multiplexer 51 in accordance with transfer clock signal ClockDR, and outputs the same as shift-out signal “Shift out”.

In the shift operation of the boundary scan test, multiplexer 51 in boundary scan cell 1 selects and outputs shift-in signal “Shift in”. Flip-flop 53 latches shift-in signal “Shift in” output from multiplexer 51 in accordance with transfer clock signal ClockDR, and outputs the same as shift-out signal “Shift out”.

As described above, the memory core according to the present embodiment is configured by simply adding boundary scan cells 1, 5, multiplexer 4 and test controller 200 to a normal memory core, and is allowed to perform the late write operation enabling a high-speed random cycle write operation, the early write operation, and the boundary scan test operation, with an increase of the circuit area being suppressed.

<Second Embodiment>

The second embodiment relates to a configuration for holding write data at the time of a late write operation in a memory core provided with a boundary scan cell of a different type from that of the first embodiment.

(Configuration)

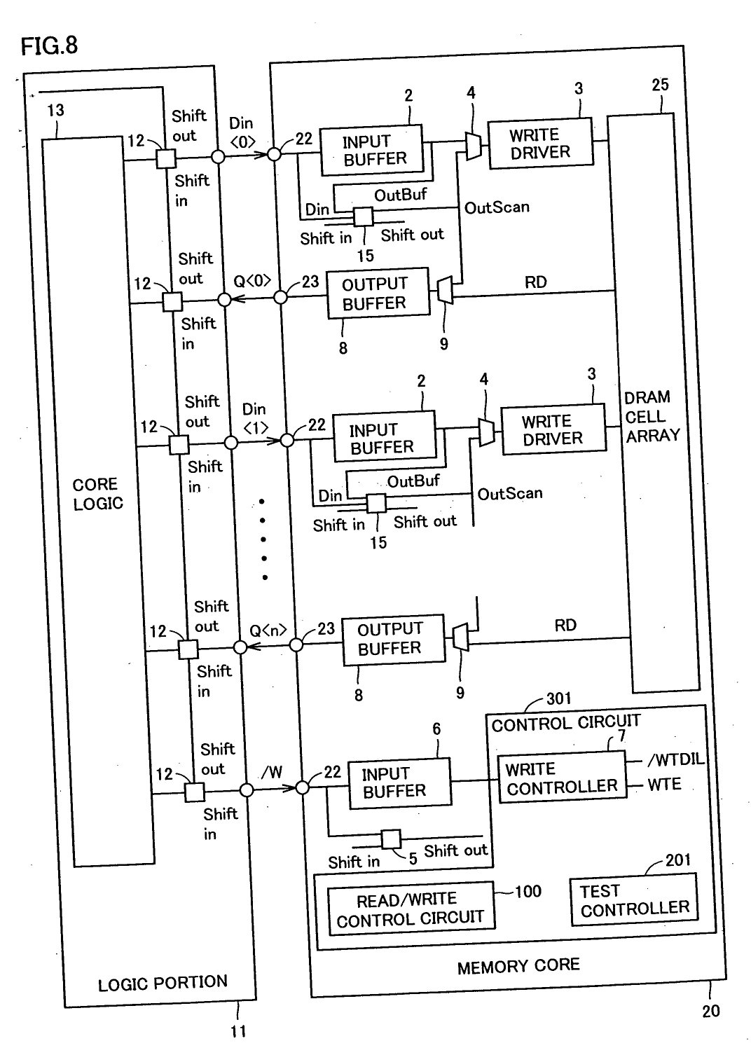

FIG. 8 shows a configuration of the system LSI according to the second embodiment. Referring to FIG. 8, the memory core 20 of the second embodiment differs from memory core 10 of the first embodiment in that it includes a boundary scan cell 15 and a test controller 201 which are different from those of the first embodiment, and in that a multiplexer 9 and an output buffer 8 are additionally provided. As shown in FIG. 8, test controller 201, read/write control circuit 100 and write controller 7 constitute a control circuit 301. Hereinafter, the above-described differences are explained.

(Test Controller 201)

Test controller 201 generates shift operation mode designating signal ShiftDR and transfer clock signal ClockDR based on an externally supplied control signal (not shown), as with test controller 200 of the first embodiment. Test controller 201 further generates an update operation mode designating signal PRELOAD and an update clock signal UpdateDR based on an externally supplied control signal (not shown). Update operation mode designating signal PRELOAD attains an H level in an update operation of the boundary scan test, and update clock signal UpdateDR is asserted (to an H level) periodically during the update operation of the boundary scan test.

(Boundary Scan Cell 15)

Boundary scan cell 15 supports an update operation in addition to the capture operation and the shift operation of the boundary scan test.

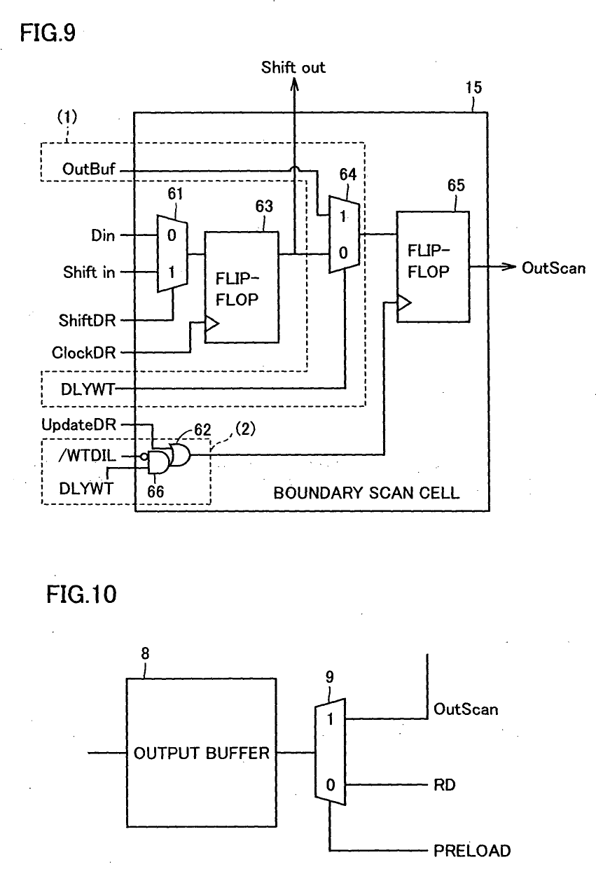

FIG. 9 shows a detailed configuration of boundary scan cell 15. Referring to FIG. 9, a multiplexer 61 is provided with input signal Din from input port 22, and shift-in signal “Shift in” from boundary scan cell 1 in the preceding stage (i.e., the boundary scan test data sent from the boundary scan cell in the preceding stage).

In the shift operation of the boundary scan test, shift operation mode designating signal ShiftDR attains an H level, and multiplexer 61 selects and outputs shift-in signal “Shift in”.

At the time other than the shift operation of the boundary scan test, multiplexer 61 selects and outputs input signal Din.

A flip-flop 63 is a one-bit shift register included in a conventional boundary scan cell. Flip-flop 63, in accordance with transfer clock signal ClockDR, latches either boundary scan test data provided as input signal Din output from multiplexer 61 (i.e., data indicating the state of input port 22 upon the test) or shift-in signal “Shift in” (i.e., boundary scan test data sent from the boundary scan cell in the preceding stage), and outputs the same as shift-out signal “Shift out”. This shift-out signal “Shift out” is input to a boundary scan cell in the succeeding stage as shift-in signal “Shift in”.

A multiplexer 64 is provided with buffer output signal OutBuf from input buffer 2, and shift-out signal “Shift out” from flip-flop 63.

In the late write operation, write operation mode select signal DLYWT attains an H level, and multiplexer 64 selects and outputs buffer output signal OutBuf.

An AND gate 66 receives an inverted signal of write data take-in signal /WTDIL and write operation mode select signal DLYWT. AND gate 66 outputs the inverted signal of write data take-in signal /WTDIL in the late write operation (i.e., when DLYWT=H level), while it outputs a signal always at an L level in the early write operation (i.e., when DLYWT.=L level).

OR gate 62 receives update clock signal UpdateDR of the boundary scan test and an output signal of AND gate 66, and provides its output to a flip-flop 65.

With AND gate 66 and OR gate 62, the inverted signal of write data take-in signal /WTDIL is output in the late write operation, the signal always at an L level is output in the early write operation, and update clock signal UpdateDR is output in the update operation of the boundary scan test.

Flip-flop 65 is an update register included in a conventional boundary scan cell. Flip-flop 65, in accordance with a signal output from the gate formed of AND gate 66 and OR gate 62, latches a signal output from multiplexer 64, and outputs the same as an output signal.

Specifically, in the late write operation, flip-flop 65 latches buffer output signal OutBuf in accordance with write data take-in signal /WTDIL, and outputs the same as scan cell output signal OutScan.

Further, in the update operation of the boundary scan test, flip-flop 65 latches shift-out signal “Shift out” output from flip-flop 63 in accordance with assertion of update clock signal UpdateDR, and outputs the same as scan cell output signal OutScan.

In FIG. 9, the portions indicated by dotted lines (1) and (2) are added to a conventional boundary scan cell. As shown in FIG. 9, boundary scan cell 15 of the present embodiment is configured by simply adding the gate formed of AND gate 66 and OR gate 62 and multiplexer 64 to the conventional boundary scan cell. As such, the circuit area of the boundary scan cell of the present embodiment is only slightly increased from that of the conventional boundary scan cell.

(Multiplexer 9)

FIG. 10 shows input/output signals of multiplexer 9. As shown in FIG. 10, multiplexer 9 receives scan cell output signal OutScan from boundary scan cell 15, and read data RD from DRAM cell array 25.

In the update operation of the boundary scan test, update operation mode designating signal PRELOAD attains an H level, and multiplexer 9 selects and outputs scan cell output signal OutScan.

At the time other than the update operation of the boundary scan test, update operation mode designating signal PRELOAD is at an L level, and multiplexer 9 selects and outputs read data RD.

(Output Buffer 8)

Output buffer 8 outputs either scan cell output signal OutScan or read data RD sent from multiplexer 9.

(Late Write Operation)

Now, an operation at the time of late write is described with reference to the timing chart shown in FIG. 6.

In the late write operation, write data DATA(n) is input to satisfy a timing defined by setup tsu(D) and hold th(D) with respect to a rising of write control signal /W (as shown in (1) in FIG. 6).

Input buffer 6 receives write control signal /W and outputs a delayed write control signal by delaying the write control signal /W by a prescribed time Δt1. Write controller 7 generates one-short pulse write data take-in signal /WTDIL (of an L level) in synchronization with a rising of the delayed write control signal (as shown in (2) in FIG. 6).

In input buffer 2, with write operation mode select signal DLYWT being at an H level, write data DATA(n) input as input signal Din is delayed by a prescribed time Δt2, passed therethrough, and output as buffer output signal OutBuf.

Multiplexer 64 in boundary scan cell 15 selects and outputs buffer output signal OutBuf as write operation mode select signal DLYWT is at an H level. Flip-flop 65 latches buffer output signal OutBuf output from multiplexer 64 in accordance with write data take-in signal /WTDIL, and outputs the same as scan cell output signal OutScan. Here, flip-flop 65 holds buffer output signal OutBuf from the time when write data take-in signal /WTDIL is asserted (to an L level) until write data take-in signal /WTDIL is asserted (to an L level) next time. That is, flip-flop 65 holes the write data input from input port 22 until a next write cycle. Multiplexer 4 selects and outputs scan cell output signal OutScan in accordance with write operation mode select signal DLYWT of an H level (as shown in (3) in FIG. 6).

Write controller 7 generates one-shot pulse write driver control signal WTE (of an H level) in synchronization with a falling of the delayed write control signal (as shown in (4) in FIG. 6).

Write driver 3 writes scan cell output signal OutScan output from multiplexer 4 into a prescribed memory cell within DRAM cell array 25 at a timing of assertion of write driver control signal WTE (to an H level) (as shown in (5) in FIG. 6).

(Early Write Operation)

Now, an operation at the time of early write is described with reference to the timing chart shown in FIG. 7.

In the early write operation, write data DATA(n) is input to satisfy a timing defined by setup tsu(D) and hold th(D) with respect to a falling of write control signal /W (as shown in (1) in FIG. 7).

Input buffer 6 receives write control signal /W and outputs a delayed write control signal by delaying the same by a prescribed time Δt1. Write controller 7 generates one-shot pulse write data take-in signal /WTDIL (of an L level) in synchronization with a falling of the delayed write control signal (as shown in (2) in FIG. 7).

In input buffer 2, with write operation mode select signal DLYWT being at an L level, write data DATA(n) input as input signal Din is delayed by a prescribed time Δt2, passed through transfer gate TG10 while write data take-in signal /WTDIL is at an H level, and latched by latch circuit 81. When write data take-in signal /WTDIL attains an L level, it is passed through transfer gate TG11 and latched by latch circuit 82, and is also output as buffer output signal OutBuf. Multiplexer 4 selects and outputs buffer output signal OutBuf, since write operation mode select signal DLYWT is at an L level (as shown in (3) in FIG. 7).

Write controller 7 generates one-shot pulse write driver control signal WTE (of an H level) in synchronization with a falling of the delayed write control signal (as shown in (4) in FIG. 7).

Write driver 3 writes input buffer output signal OutBuf output from multiplexer 4 into a prescribed memory cell within DRAM cell array 25 at the timing of assertion of write driver control signal WTE (to an H level) (as shown in (5) in FIG. 7).

(Boundary Scan Test Operation)

Now, an operation at the time of boundary scan test is described.

In the capture operation of the boundary scan test, multiplexer 61 in boundary scan cell 15 selects and outputs the boundary scan test data input as input signal Din. Flip-flop 63 latches input signal Din output from multiplexer 61 in accordance with transfer clock signal ClockDR, and outputs the same as shift-out signal “Shift out”.

In the shift operation of the boundary scan test, multiplexer 61 in boundary scan cell 15 selects and outputs shift-in signal “Shift in” (i.e., boundary scan test data sent from the boundary scan cell in the preceding stage). Flip-flop 63 latches shift-in signal “Shift in” output from multiplexer 61 in accordance with transfer clock signal ClockDR, and outputs the same as shift-out signal “Shift out”.

In the update operation of the boundary scan test, multiplexer 64 selects and outputs shift-out signal “Shift out” output from flip-flop 63 (i.e., the boundary scan test data sent from the boundary scan cell in the preceding stage). Flip-flop 65 latches shift-out signal “Shift out” output from multiplexer 64 in accordance with update clock signal UpdateDR, and outputs the same as scan cell output signal OutScan. In the update operation of the boundary scan test, update operation mode designating signal PRELOAD is at an H level, so that multiplexer 9 selects and outputs scan cell output signal OutScan. Output buffer 8 outputs scan cell output signal OutScan to output port 23.

As described above, the memory core according to the present embodiment is capable of performing the late write operation enabling a high-speed random cycle write operation, the early write operation, and the boundary scan test operation, while it is configured by simply adding boundary scan cells 15, 5, multiplexers 4, 9 and test controller 201 to a normal memory core. Thus, an increase of the circuit area is suppressed.

<Modification>

The present invention, not limited to the above-described embodiments, includes the following modifications, for example.

(1) Write Operation Mode Select Signal DLYWT

In the embodiments of the present invention, read/write control circuit 100 is used to switch the level of write operation mode select signal DLWYT. The present invention, however, is not limited thereto.

For example, metal interconnections can be switched by masking, or bonding can be switched by wire bonding. Furthermore, a control signal from logic portion 11 can be used for switching in the initialization sequence of the memory core.

(2) Early Write Operation

In the embodiments of the present invention, a configuration which can select and execute one of the early write operation, the late write operation permitting a high-speed random cycle write operation, and the boundary scan test has been described. The present invention, however, is not limited thereto. It can be configured to select and execute either the late write operation permitting a high-speed random cycle write operation or the boundary scan test. In this case, the device configuration is further simplified.

(3) Test Controller

In the embodiments of the present invention, memory cores 10, 20 are provided with test controllers. The present invention, however, is not limited thereto. A test controller may be provided in logic portion 11, and a control signal for the boundary scan test may be sent from logic portion 11 to memory cores 10, 20.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A semiconductor memory device having a logic and a memory and selectively performing a late write operation and a boundary scan test operation, comprising:
a terminal receiving write data;
an input buffer provided corresponding to said terminal;
a boundary scan cell provided corresponding to said terminal and including a first register holding boundary scan test data at the time of said boundary scan test and holding write data to said memory supplied from said terminal at the time of said late write operation in accordance with inactivation of a write control signal;
a first selector receiving an output of said input buffer and an output of said boundary scan cell and selecting the output of said boundary scan cell in said late write operation; and
a write driver for writing the output selected by said selector into said memory.

2. The semiconductor memory device according to claim 1, wherein said boundary scan cell receives said boundary scan test data and the output of said input buffer, and said first register holds the output from said input buffer in said late write operation.

3. The semiconductor memory device according to claim 2, wherein said input buffer includes a latch circuit which holds the write data input from said terminal in an early write operation in accordance with activation of the write control signal and lets said write data through for output in said late write operation.

4. The semiconductor memory device according to claim 3, further comprising a control circuit which generates a one-shot pulse write data take-in signal in said early write operation based on a leading edge of a pulse of said write control signal and generates a one-shot pulse write data take-in signal in said late write operation based on a trailing edge of a pulse of said write control signal, wherein
said boundary scan cell further includes
a second selector which receives an output of said input buffer, an input from said terminal and an output of a boundary scan cell in a preceding stage, and outputs the output of the boundary scan cell in the preceding stage in a shift operation of said boundary scan test, outputs the output of said input buffer in said late write operation, and outputs the input from said corresponding terminal at the time other than said shift operation and said late write operation, and
a logic gate which outputs said write data take-in signal in the late write operation, and outputs a clock signal for capturing and shifting of the boundary scan test in the capture and shift operations of the boundary scan test,
said first register latches an output of said second selector in accordance with an output of said logic gate, and outputs the same to a boundary scan cell in a succeeding stage and to said first selector, and
said first selector outputs the output of said input buffer in said early write operation and outputs the output of said boundary scan cell in said late write operation.

5. The semiconductor memory device according to claim 3, further comprising a control circuit which generates a one-shot pulse write data take-in signal in said early write operation based on a leading edge of a pulse of said write control signal and generates a one-shot pulse write data take-in signal in said late write operation based on a trailing edge of a pulse of said write control signal, wherein
said boundary scan cell further includes
a second selector which receives an input from said terminal and an output of a boundary scan cell in a preceding stage, and outputs the output of the boundary scan cell in the preceding stage in the shift operation of said boundary scan test, and outputs the input from said terminal at the time other than said shift operation,
a second register which latches an output of said second selector in accordance with a clock signal for capturing and shifting of said boundary scan test, and outputs the same to a boundary scan cell in a succeeding stage,
a third selector which receives an output of said input buffer and an output of said second register and outputs the output of said input buffer in said late write operation and outputs the output of said second register at the time other than said late write operation, and
a logic gate which outputs said write data take-in signal in the late write operation and outputs a clock signal for updating of the boundary scan test in the update operation of the boundary scan test,
said first register latches an output of said third selector in accordance with an output of said logic gate, and outputs the same to said first selector, and
said first selector outputs the output of said input buffer in said early write operation and outputs an output of said boundary scan cell in said late write operation.
